(19) United States
(12) Patent Application Publication
(10) Pub. No.: US 2019/0164247 A1
(43) Pub. Date: May 30, 2019

(54) METHOD AND APPARATUS FOR TRANSPORTATION WIRELESS AUTHORIZATION

(71) Applicant: FORD GLOBAL TECHNOLOGIES, LLC, Dearborn, MI (US)

(72) Inventors: Florian FRISCHMUTH, Plymouth, MI (US); Richard A. LEACH, Troy, MI (US)

(21) Appl. No.: 15/824,162

(22) Filed: Nov. 28, 2017

(51) Int. Cl. G06Q 50/30; G08G 1/00; G01C 21/34; G06Q 10/04

(52) U.S. Cl. CPC G06Q 50/30; G08G 1/202; H04W 4/008; G06Q 10/047; G01C 21/3461

(57) ABSTRACT

A system includes a processor configured to receive a transportation request from a traveler. The processor is also configured to determine that an aspect of the transportation request corresponds to a predefined condition requiring approval from a predefined non-traveler person before processing the transportation request. The processor is further configured to send an approval request to the non-traveler person and block execution of the transportation request until approval is received from the non-traveler person.

### TECHNICAL FIELD

The illustrative embodiments generally relate to methods and apparatuses for transportation wireless authorization.

### BACKGROUND

Parents (and caretakers for the elderly) have always been concerned about journeys being made by their wards. Through use of features such as navigation history, some retrospective insight can be gained on these journeys, but if the ward is currently traveling and falls out of contact, for example, a person may not even know where to look.

Managed transportation services, such as on-demand ride hailing and, eventually, autonomous vehicles, may provide opportunities for travel that do not even involve a vehicle under control of a guardian. That is, the guardian cannot configure the vehicle to restrict travel or report travel, because the guardian has no actual access to the vehicle. This can allow for wards to travel to prohibited locations, through prohibited locations, and to unexpected locations without significant reporting or restrictive capability.

### SUMMARY

In a first illustrative embodiment, a system includes a processor configured to receive a transportation request from a traveler. The processor is also configured to determine that an aspect of the transportation request corresponds to a predefined condition requiring approval from a predefined non-traveler person before processing the transportation request. The processor is further configured to send an approval request to the non-traveler person and block execution of the transportation request until approval is received from the non-traveler person.

In a second illustrative embodiment, a computer-implemented method includes delaying execution of a travel request from a traveler, which includes at least one parameter corresponding to predefined parameters requiring predefined non-traveling party approval, until approval is received from the non-traveling party, responsive to an approval request sent responsive to identifying the at least one parameter.

In a third illustrative embodiment, a computer-implemented method includes receiving a ride-hailing request. The method also includes determining if an aspect of the ride-hailing request corresponds to a predefined parameter requiring approval, from a predefined guardian, to process the request. The method further includes sending an electronic approval request to the guardian responsive to the determining and delaying execution of the request until the guardian responds, with approval, to the approval request.

### BRIEF DESCRIPTION OF THE DRAWINGS

FIG. 1 shows an illustrative vehicle computing system;

FIG. 2 shows an illustrative process for approving a route;

FIG. 3 shows an illustrative process for determining when approval is needed;

FIG. 4 shows an illustrative approval process; and

FIG. 5 shows an illustrative process for approving a transportation mode.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

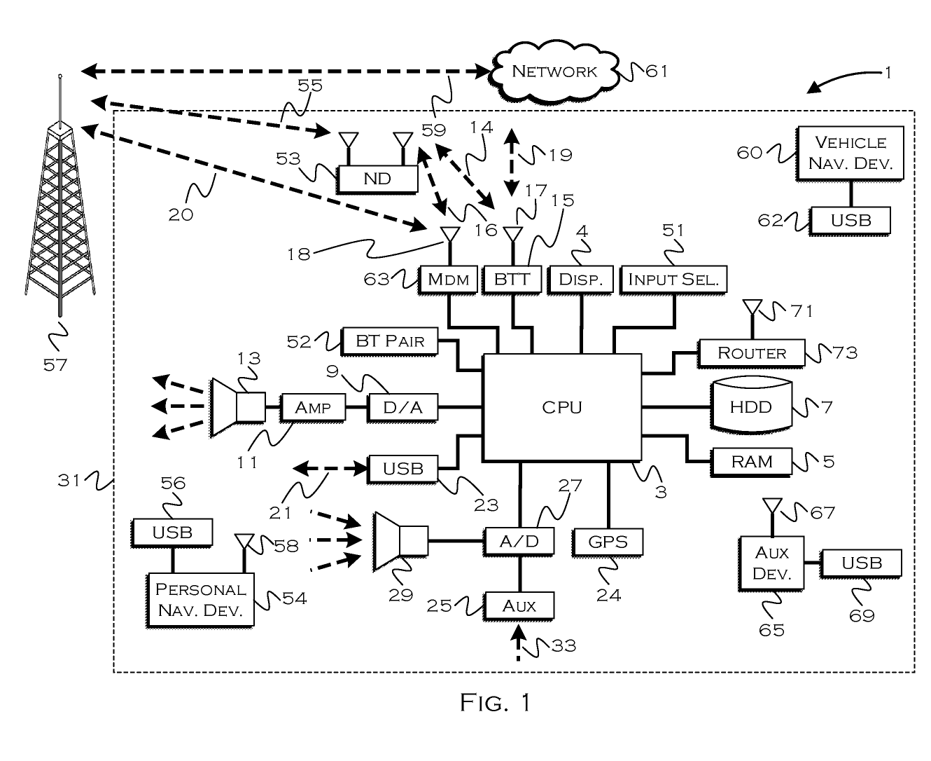

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Parents or guardians may want to impose a level of travel control over their charges, which, in times past, typically meant verbally imposing restrictions and punishing offenders when the offense was discovered. In more recent times, it may be possible to use a vehicle computer to constrain travelable areas, or cause reporting if a vehicle is out-of-area, but this typically requires access to the vehicle.

With many on-demand services now available, and with more options soon to be available in the form of autonomous vehicles, the idea of restricting travel for a personal vehicle may soon be relatively obsolete. That said, all of the concepts disclosed herein that have applicability to personal vehicles can be used in conjunction with personal vehicles in a manner that will be understandable from the various descriptions. The remaining concepts relating to alternative transportation address other situations where a guardian or parent may not actually own the vehicle in use.

In the illustrative embodiments, whenever a user wants to travel a route or use a transportation service, the process can use the illustrative embodiments and the like, to determine if parental approval is required before transportation can proceed. So, in the case of a personal vehicle, inputting an impermissible route may require approval before the route guidance will begin. In the case of an on-demand service, the type of service, a planned route or a destination may require approval before the user can actually access a service to hire the vehicle. This can allow guardians to provide their charges with on-demand transportation services, without fear of unapproved rides or destinations. This feature could be integrated into a parental watchdog application or into various on-demand applications directly, among other possible implementations.

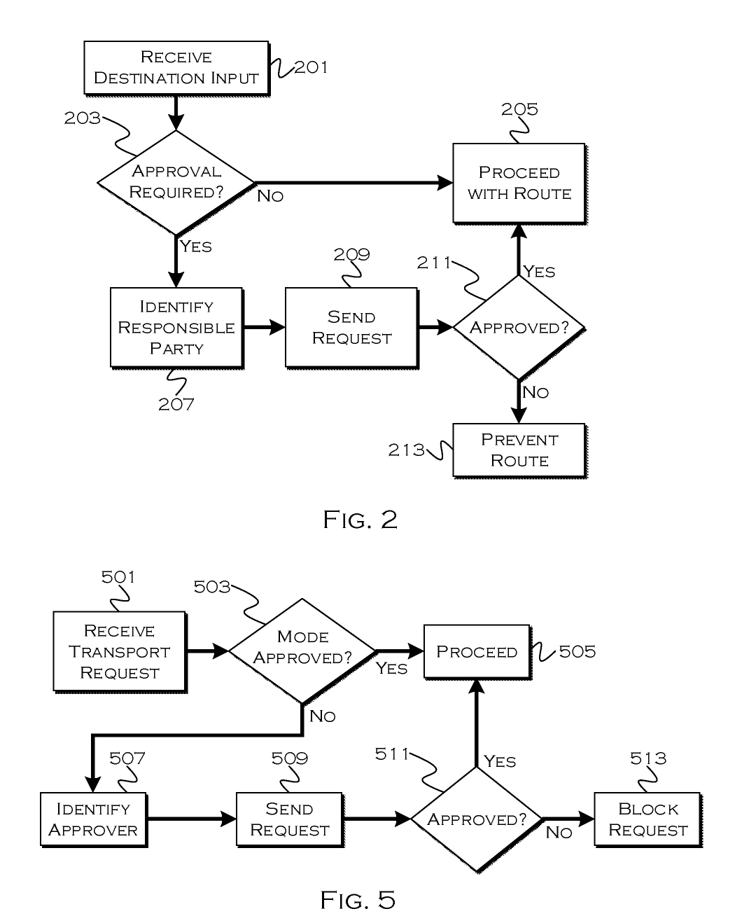

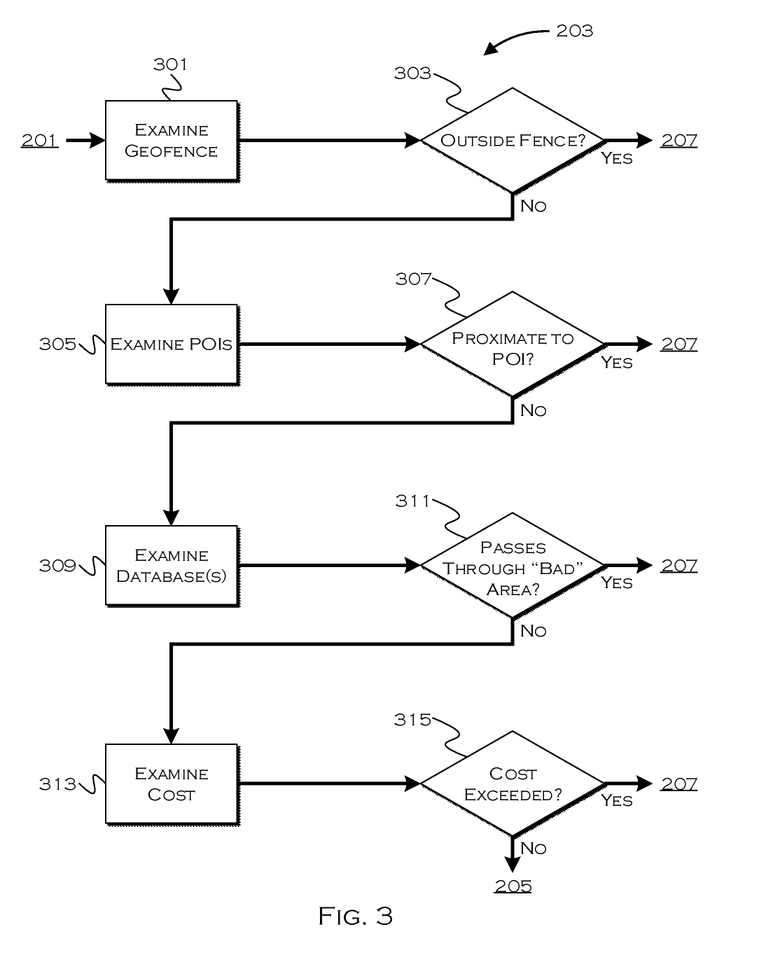

FIG. 2 shows an illustrative process for approving a route. In this example, the passenger is requesting a route which may either be through a known, personal vehicle or via a device using on-demand services. The guardian process receives 201 a destination input and determines 203 if guardian approval is required (for various reasons, examples of which are presented with respect to FIG. 3).

If the route does not require guardian approval, the process may allow 205 the user to proceed with the route in question, whether this means permitting an on-demand ride-hailing, a vehicle navigation process, or other similar event.

If the route requires guardian approval for some reason, the process may identify 207 one or more responsible parties who are required to give approval before a ride or route can continue. This could include multiple parties, any one of whom may be able to provide approval, as well as approval requests being sent to each party via multiple forms of communication, such as text, email, application messaging, etc. Individual users can configure guardianship and communication parameters as appropriate.

Once the process sends 209 the request, the process waits to see if the request was approved 211 by any authorized guardian. If the request was approved, the process allows 205 the requested route to continue, and if the request was denied, the process may prevent 213 execution of the route (blocking the service, blocking the request, preventing navigation, etc). The process may also provide the guardian with an option to “automatically approve” certain requests, so that a request need not be repeated if the request parameters meet an automatically approved set of parameters (destination, cost, time of day, path, etc).

FIG. 3 shows an illustrative process for determining when approval is needed. In this example, the process demonstrates several considerations (among many variants) that could be used as a basis for requiring approval. These considerations could extend beyond those shown, and could be user configurable so that some or all either do not apply, or only apply subject to certain parameters (e.g., within certain times of day).

In this example, the process examines 301 a geo-fence or multiple geo-fences set as restricting user travel. These fences could define areas of permissible travel, areas of impermissible travel, areas of permissible destinations, areas of impermissible destinations, etc. If a route or destination (depending on the nature of the fences) carries a user outside a fence 303, the process could branch to an approval request 207. A configuration may include both types of fences, and the fences themselves could apply based on contingent variables (weather, time of day, day of week, etc).

Also, in this example, the process examines 305 a list of restricted points of interest (POIs) to determine if a destination (or route) is proximate to a restricted POI 307. If the destination or route is proximate to the POI, the process requests approval.

The process further examines 309 a database of statistics relating to prohibited areas. This could include, for example, a crime statistics database, a wild-life attack statistics data base, etc. Any database identifying regions that could affect a route determination may be assignable as a parameter, with constraints based on tierings identified by the database. If the route or destination passes through or exists in a “bad” area 311 (defined by selection of database parameters), the process requests approval.

Finally, in this example, the process examines 313 the cost of a trip. Parameters such as cost may only apply to hired-ride situations, but these sorts of parameters can be reasonably adapted as needed. If the cost exceeds a permissible level 315, the process requests approval.

The process may also consider other conditional variables, such as time or weather, as actual constraints on approval as opposed to merely constraining other parameter application. That is, if a route passes through bad weather or a destination is reached after a curfew, the process may require approval. These are just a few of many parameters that can be used to define when guardian-approval is required for a route or ride-sharing solution to be used. Any reasonable constraint, including type of business (e.g., a bar) or destination identity (e.g., a specific business) could also be implemented.

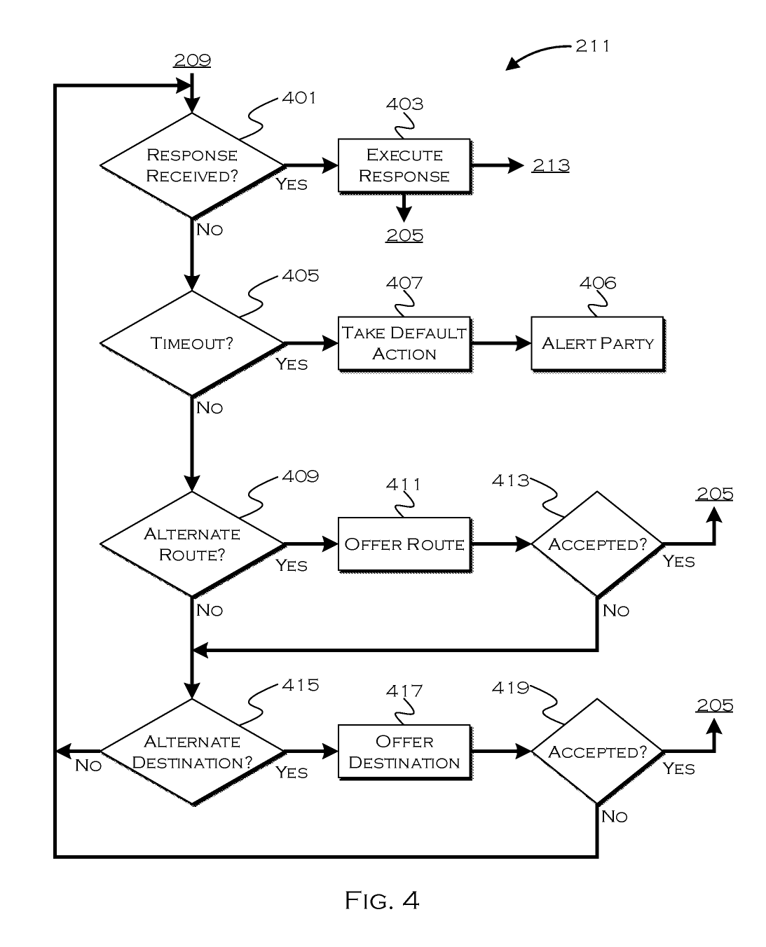

FIG. 4 shows an illustrative approval process. In this example, the process determines 401 if a response has been received to an approval request. If there is an explicit “yes” or “no,” the process can execute 403 the response (e.g., approve or block the route or transportation). If there is not a route, the process may use a timeout 405 consideration, after which the process takes 407 a default action, defined either for the user generically (e.g., approval all, reject all) or defined based on some parameters associated with the route or transportation mode (e.g., the default action is conditional). The process may also alert 406 a guardian via a separate notification if the default action is engaged, so the guardian knows what action was taken.

Also, in this example, the process considers 409 if an alternate, approved route (or alternate, approved transportation option) exists. This could be a longer route through “safer” areas, or a different transportation vendor, etc. If there is an alternate option that can be used, the process offers 411 the alternative. The user can accept or reject the route 413, or can conditionally accept (e.g., if approval is not received, the user accepts). In another example, the guardian can be notified of the suitable alternative and can approve the alternative as the only approved option.

Similarly, the process determines if there is an alternate destination 415. An alternate destination may not be suitable in many cases, because the user may have a goal in mind at a specific destination, but if, for example, the user simply wants a hamburger, there may be plenty of suitable alternative options. Thus, the process can offer 417 a similar but different alternative (as opposed to the above example, which may still get the user to the destination requested, through a different route/method). If the user accepts, the process can proceed. Again, the guardian may also receive an option to select the alternative as an approved or the “only approved” option.

FIG. 5 shows an illustrative process for approving a transportation mode. Similar to the route approval process, this process determines if a requested for-hire transportation method is approved and blocks or permits a request to hire the vehicle.

Since certain modes of transportation may be always approved, the process determines 503 if conditions (such as those in FIG. 3) dictate required approval before proceeding. This concept could be integrated into ride-hailing applications, or could be part of a stand-alone watchdog application. For example, a request to use RIDEHAIL could be always approved, unless the request was for a shared (with unknown others) or luxury vehicle. On the other hand, any request to use HAILRIDE (a presumably less safe, more expensive, etc. service) may require approval.

Again, the process identifies 507 one or more parties who can give approval, and sends 509 a request to those parties for approving the request. All of the approval constraints, alternative options and timeout considerations could apply to this request. If the request is approved 511, the user is allowed to proceed with the ride-hailing. If the request is denied, the user is blocked 513 from hailing the ride, which could include either temporarily blocking the application used for hailing the ride, or merely blocking the current request (allowing the user to submit another request). The block could also include a condition dictated by the guardian, such as, for example, you cannot use HAILRIDE unless you are going to X destination, or you cannot use RIDEHAIL unless you select a non-shared vehicle. Any of these “permitted options” could then be presented to the user as an alternative to the original request, with pre-approval already included.

Through use of the illustrative embodiments and the like, parents and guardians can control and manage wards in a world of ever increasing transportation options. This allows the guardian to achieve at least some peace of mind, without having to require complete prohibition of use of a service, application or vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
receive a transportation request from a traveler;
determine that an aspect of the transportation request corresponds to a predefined condition requiring approval from a predefined non-traveler person before processing the transportation request;
send an approval request to the non-traveler person; and
block execution of the transportation request until approval is received from the non-traveler person.

2. The system of claim 1, wherein the transportation request includes a ride-hailing request.

3. The system of claim 2, wherein the aspect includes a ride-hailing service identity.

4. The system of claim 2, wherein the aspect includes a total cost.

5. The system of claim 2, wherein the aspect includes a destination.

6. The system of claim 2, wherein the aspect includes a route.

7. The system of claim 1, wherein the transportation request includes a destination request.

8. The system of claim 7, wherein the aspect includes a projected arrival time.

9. The system of claim 7, wherein the aspect includes a route to the destination.

10. The system of claim 9, wherein the aspect includes a weather condition affecting a portion of the route.

11. The system of claim 9, wherein the aspect includes a predefined safety constraint affecting a portion of the route.

12. The system of claim 7, wherein the aspect includes a destination location.

13. The system of claim 7, wherein the aspect includes a destination identity.

14. The system of claim 7, wherein the aspect includes a destination business-type.

15. The system of claim 1, wherein the processor is further configured to:
receive traveler selection of a predefined pre-approved alternative to the transportation request; and
execute the predefined pre-approved alternative.

16. A computer-implemented method comprising:
delaying execution of a travel request from a traveler, which includes at least one parameter corresponding to predefined parameters requiring predefined non-traveling party approval, until approval is received from the non-traveling party, responsive to an approval request sent responsive to identifying the at least one parameter.

17. The method of claim 16, wherein the travel request includes a routing request.

18. The method of claim 16, wherein the travel request includes a ride-hailing request.

19. The method of claim 16, further comprising:
presenting an alternative travel option to the travel request, representing a travel option for which no non-traveling party approval is required; and
executing the alternative travel option responsive to acceptance of the travel option from the traveler.

20. A computer-implemented method comprising:
receiving a ride-hailing request;
determining if an aspect of the ride-hailing request corresponds to a predefined parameter requiring approval, from a predefined guardian, to process the request;
sending an electronic approval request to the guardian responsive to the determining; and
delaying execution of the request until the guardian responds, with approval, to the approval request.
